(19) United States
(12) Patent Application Publication
(10) Pub. No.: US 2019/0034039 A1
(43) Pub. Date: Jan. 31, 2019

(54) NOTIFICATION FIELD DISPLAY METHOD, DEVICE, AND ELECTRONIC APPARATUS

(71) Applicant: BEIJING KINGSOFT INTERNET SECURITY SOFTWARE CO., LTD., Beijing (CN)

(72) Inventors: Sofong Hsieh, Beijing (CN); Shuhsin Yang, Beijing (CN)

(73) Assignee: BEIJING KINGSOFT INTERNET SECURITY SOFTWARE CO., L TD., Beijing (CN)

(21) Appl. No.: 16/055,235

(22) Filed: Aug. 6, 2018

Related U.S. Application Data
(63) Continuation of application No. PCT/CN2017/074818, filed on Feb. 24, 2017.

(30) Foreign Application Priority Data
Jun. 29, 2016 (CN) 201610498585.3

(51) Int. Cl. G06F 3/0481; G06F 17/27; H04W 4/14

(52) U.S. Cl. CPC G06F 3/0481; H04W 4/14; G06F 17/277; G06F 17/2705

(57) ABSTRACT

The present disclosure provides a display method of a notification bar, a display device of a notification bar and an electronic device. The display method includes: acquiring a message to be displayed in the notification bar; determining whether a condition for performing enhanced display on the message is satisfied according to the message to be displayed in the notification bar; and when the condition for performing enhanced display on the message is satisfied, setting a property of the message to be displayed in the notification bar, such that the enhanced display is performed on message to be displayed in the notification bar according to a predetermined enhanced display manner. Whether the condition for preforming enhanced display on the message is satisfied is determined based on an application for generating the message to be displayed in notification bar, content of the message and a user for receiving the message.

### CROSS REFERENCE TO RELATED APPLICATIONS

This application is a continuation of International Application No. PCT/CN2017/074818, filed on Feb. 24, 2017, which claims a priority to Chinese Pat Application Serial No. 201610498585.3, filed with the State Intellectual Property Office of P. R. China on Jun. 29, 2016, by BEIJING KINGSOFT INTERNET SECURITY SOFTWARE CO., LTD., and titled with “Notification Field Display Method, Device, and Electronic Device”, the entire contents of both of which are incorporated herein by reference.

### FIELD

The present disclosure relates to a field of notification bar display technology, and more particularly, to a display method of a notification bar, a display device of a notification bar and an electronic device.

### BACKGROUND

With continuous development of computer communication and Internet technology, electronic devices, such as smart mobile phones, personal digital assistants (PDAs), palm-sized computers and laptop computer, are becoming more and more widely used. Some communication applications are favored by more and more users due to the capability of interactive communication with others. After receiving information sent by other users or a network operator, such as short message service (SMS), news information, application promotion information, weather information, game online information, travel information, and off-price information, the information received may pop up in a notification bar to display so that the user may view the information in time.

### SUMMARY

Embodiments of the present disclosure provide a display method of a notification bar. The display method includes:

acquiring a message to be displayed in the notification bar;

determining whether a condition for performing enhanced display on the message is satisfied according to the message to be displayed in the notification bar; and

when the condition for performing the enhanced display on the message is satisfied, setting a property of the message to be displayed in the notification bar, such that the enhanced display is performed on the message to be displayed in the notification bar according to a predetermined enhanced display manner;

in which determining whether the condition for performing the enhanced display on the message is satisfied according to the message to be displayed in the notification bar includes:

determining an application for generating the message to be displayed in the notification bar according to the message to be displayed in the notification bar;

determining whether the application for generating the message to be displayed in the notification bar is a predetermined target application; and

determining that the condition for performing the enhanced display on the message is satisfied when the application for generating the message to be displayed in the notification bar is the predetermined target application;

or, determining whether the condition for performing the enhanced display on the message is satisfied according to the message to be displayed in the notification bar includes:

parsing content of the message to be displayed in the notification bar according to the message to be displayed in the notification bar;

determining whether a predetermined key word exists in the content of the message to be displayed in the notification bar; and

when the predetermined key word exists in the content of the message to be displayed in the notification bar, determining that the condition for performing the enhanced display on the message is satisfied;

or, determining whether the condition for performing the enhanced display on the message is satisfied according to the message to be displayed in the notification bar includes:

determining an application for generating the message to be displayed in the notification bar and a user for receiving the message to be displayed in the notification bar according to the message to be displayed in the notification bar;

determining whether the application for generating the message to be displayed in the notification bar is a predetermined target application and whether the user for receiving the message to be displayed in the notification bar is a predetermined target user; and

when the application for generating the message to be displayed in the notification bar is the predetermined target application and the user for receiving the message to be displayed in the notification bar is the predetermined target user, determining that the condition for performing the enhanced display on the message is satisfied.

Embodiments of the present disclosure provide an electronic device. The electronic device includes a housing, a processor, a memory, a circuit board and a power supply circuit. The circuit board is enclosed by the housing. The processor and the memory are positioned on the circuit board. The power supply circuit is configured to provide power for respective circuits or components of the terminal device. The memory is configured to store executable program codes. The processor is configured to run a program corresponding to the executable program codes by reading the executable program codes stored in the memory, to perform the display method of a notification bar described above.

Embodiments of the present disclosure provide a non-transitory computer readable storage medium. The non-transitory computer readable storage medium is configured to store an application. The application is configured to execute the display method of a notification bar described above.

### BRIEF DESCRIPTION OF THE DRAWINGS

In order to further clearly describe technical solutions of embodiments of the present disclosure, simply descriptions will be made to drawings necessitated by describing embodiments of the present disclosure or related arts. Obviously, the drawings described below are merely some embodiments of the present disclosure, and other drawings may be obtained by those skilled in the art without any inventive labors according to these drawings.

FIG. 1 is a schematic diagram of displaying a message in a notification bar in related arts;

FIG. 2 is a flow chart illustrating a display method of a notification bar according to Embodiment One of the present disclosure.

FIG. 3 is a schematic diagram of displaying a notification bar provided in a display method of a notification bar according to embodiments of the present disclosure;

FIG. 4 is a flow chart illustrating a display method of a notification bar according to Embodiment Two of the present disclosure;

FIG. 5 is a flow chart illustrating a display method of a notification bar according to Embodiment Three of the present disclosure;

FIG. 6 is a flow chart illustrating a display method of a notification bar according to Embodiment Four of the present disclosure;

FIG. 7 is a block diagram illustrating a display device of a notification bar according to Embodiment One of the present disclosure;

FIG. 8 is a block diagram illustrating a display device of a notification bar according to Embodiment Two of the present disclosure;

FIG. 9 is a block diagram illustrating a display device of a notification bar according to Embodiment Three of the present disclosure;

FIG. 10 is a block diagram illustrating a display device of a notification bar according to Embodiment Four of the present disclosure; and

FIG. 11 is a schematic diagram illustrating an electronic device according to an embodiment of the present disclosure.

### DETAILED DESCRIPTION

Embodiments of the present disclosure will be described in detail with reference to drawings.

It is to be understood that, the described embodiments are merely parts of embodiments instead of all embodiments of the present disclosure. Based on the embodiments illustrated in the present disclosure, other embodiments obtained by those skilled in the art without any inventive labor are all covered by the scope of the present disclosure.

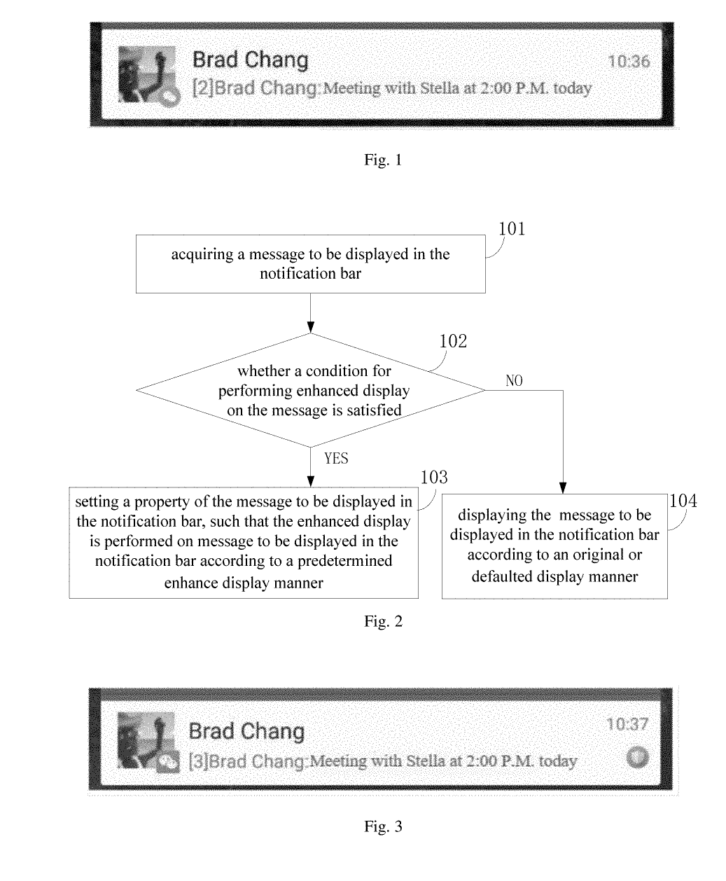

In an existing display method of a notification bar, a message pops up using the notification bar in a common notification style, as illustrated in FIG. 1. FIG. 1 is a schematic diagram of displaying a message in the notification bar in related arts.

However, the method of displaying a message in the notification bar is important differently importance to the users. For example, for some online game applications, the notification may be pushed to players at a specific time. But, for a common player, they expect to not be overly disturbed and thus a strong reminder or display is not desired. By contrary, for a crazy player, the notification information is very important. However, the information displayed in the notification bar is unable to satisfy individual requirements of various users, and the information displayed in the notification bar is less precise. Further, for the communication application, most of the notification information displayed in the notification bar may be less important, while the notification information may be important for a receiver of the notification information when specific content (such as a specific person or a specific event) is involved in the notification information. Therefore, it is required to notify strongly the user of specific content to enhance the notification function of the notification bar. However, the existing display method of the notification bar is unable to implement the above function, thereby bringing inconvenience to the user.

Embodiments of the present disclosure provide a display method of a notification bar, a display method of a notification bar and an electronic device.

With the display method of a notification bar, a display device of a notification bar and an electronic device provided in embodiments of the present disclosure, by acquiring the message to be displayed in the notification bar, it is determined whether the condition for performing the enhanced display on the message is satisfied according to the acquired message to be displayed in the notification bar. When the conditioner for performing the enhanced display on the message is satisfied, the property of the message to be displayed in the notification bar is set, such that the enhanced display is performed on the message to be displayed in the notification bar according to the predetermined enhanced display manner, thereby improving effectiveness of prompt by the notification bar.

FIG. 2 is a flow chart illustrating a display method of a notification bar according to Embodiment One of the present disclosure. As illustrated in FIG. 2, the method provided in embodiments may include the following.

In block 101, a message to be displayed in the notification bar is acquired.

In embodiments, some applications particularly communication applications, such as WeChat, QQ, Line, Facebook, Messenger, WhatsApp, Skype, may be configured to implement interactions and communications among users. After the communication application receives information sent by other users and a network operator, such as short message service, news information, application promotion information, weather information, game online information, travel information, and off-price information, the information received may be displayed in a notification bar so that the user may view the information in time.

In embodiments, before displaying the message in the notification bar, the message to be displayed in the notification bar may be acquired in following optional manners.

As an optional manner, a message to be sent to the notification bar may be acquired in a system application framework layer as the message to be displayed in the notification bar. In particular, in Android operating system, information in the message to be displayed in the notification bar may be acquired via a method of NotificationManaagerService.

As another optional manner, an interception program such as hook function may be injected to a message progress of the notification bar to acquire the message to be displayed in the notification bar.

In the above implementation manner, by injecting the interception program into the message progress of the notification bar, an original message processing application of the notification bar in the message progress of the notification bar is replaced with the interception program. Therefore, the message to be displayed in the notification bar may be acquired using the interception program. In addition to an interception feature realized in the present disclosure, the injected interception program also has features realized by the hook function substantially similar to features realized by a function in the replaced original message processing program of the notification bar.

As still another optional manner, a usage permission of the notification bar may be acquired. The message to be displayed in the notification bar is acquired by monitoring a message to be displayed the notification bar in a system. In particular, the usage permission of the notification bar may be acquired, and the message to be displayed in the notification bar in the system is monitored using a notification listener service class member function to acquire the message to be displayed in the notification bar.

In block 102, it is determined whether a condition for performing enhanced display on the message is satisfied.

In embodiments, it is determined whether the condition for performing the enhanced display on the message is satisfied according to the acquired message to be displayed in the notification bar.

Performing the enhanced display on the message to be displayed in the notification bar refers to that message to be displayed in the notification bar is displayed in a manner other than an original or defaulted display manner, such that the user may pay a particular attention to the message to be displayed in the notification bar.

The condition for performing the enhanced display on the message may be preset in advance. The condition for performing the enhanced display on the message may be set in advance in combination with several aspects, such as an application for generating the message to be displayed in notification bar, content of the message to be displayed in notification bar, a user for receiving the message to be displayed in notification bar and the like.

Through the determination, if the condition for performing the enhanced display on the message is satisfied, a block 103 is executed; otherwise, a block 104 is executed.

In block 103, a property of the message to be displayed in the notification bar is set, such that the enhanced display is performed on the message to be displayed in the notification bar according to a predetermined enhanced display manner.

In embodiments, setting the property of the message to be displayed in the notification bar may include setting at least one of following, on the basis of an original property set of the message to be displayed in the notification bar.

A key word in content of the message to be displayed in the notification bar is set to a predetermined color and/or a predetermined font.

A prompt effect in voice or in vibration is set, for example, setting a specific voice manner and/or a specific vibration manner.

Display priority information is set.

A first notification mark is set. The first notification mark indicates that the notification bar is an enhanced prompt notification bar.

A second notification mark is set. The second notification mark represents an application for generating the message to be displayed in the notification bar.

FIG. 3 is a schematic diagram illustrating a display of a notification bar according to a display method of a notification bar provided in embodiments of the present disclosure. In FIG. 3, the key work “Stella” is striking and red. The first notification mark is under the date on the left side, while the second notification mark, the logo of WeChat, is near a head portrait on the right side.

In embodiments, on the basis of the original property of the message to be displayed in the notification bar, the property of the message to be displayed in the notification bar is set for the purpose of maintaining an original appearance of the notification bar and other setups of the message to be displayed in the notification bar. For example, a click operation event and actions for triggering cancellation or deletion are unchanged to keep user cognitions and usage habits. The present disclosure is not limited thereto, and the original property of the message to be displayed in the notification bar may be reset.

In embodiments, by setting the property of the message to be displayed in the notification bar the enhanced display manner is set, such that when the message to be displayed in the notification bar is displayed, the enhanced display may be performed on the message according to the predetermined enhanced display manner.

When the enhanced display is performed on the message, the acquired message to be displayed in the notification bar may be displayed directly in the original notification bar according to the predetermined enhanced display manner. Alternatively, displaying the original notification bar configured for displaying the message to be displayed in the notification bar may also be cancelled, such that the message to be displayed in the notification bar is displayed in a newly established notification bar according to the predetermined enhanced display manner. For example, when the message to be displayed in the notification bar is acquired under a case that the message to be displayed in the notification bar is monitored in the system by acquiring the usage permission of the notification bar, in order to avoid an interference caused by popping the original notification bar up, it is required to cancel to display the original notification bar configured for displaying the message to be displayed in the notification bar, such that the message to be displayed in the notification bar is displayed in the newly established notification bar according to the predetermined enhanced display manner.

In block 104, the message to be displayed in the notification bar is displayed according to an original or defaulted display manner.

In embodiments of the present disclosure, by acquiring the message to be displayed in the notification bar, it is determined whether the condition for performing the enhanced display on the message is satisfied according to the message to be displayed in the notification bar. If the condition for performing the enhanced display on the message is satisfied, the property of the message to be displayed in the notification bar is set, such that the enhanced display may be performed on the message to be displayed in the notification bar according to the predetermined enhanced display manner. Therefore, the user may pay particular attention to the message to be displayed in the notification bar, thereby improving effectiveness of prompt of the notification bar.

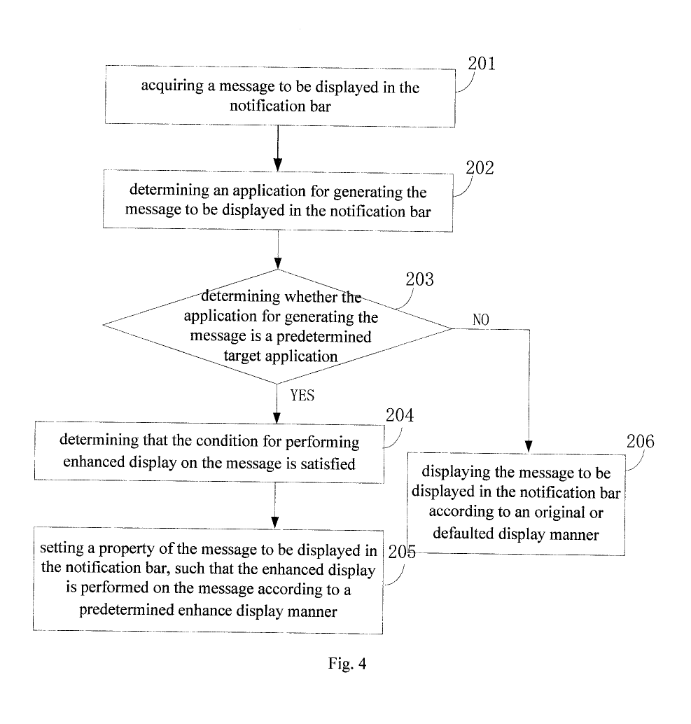

FIG. 4 is a flow chart illustrating a display method of a notification bar provided in Embodiment Two of the present disclosure. As illustrated in FIG. 4, the method in embodiments may include the followings.

In block 201, a message to be displayed in the notification bar is acquired.

In embodiments, a process of acquiring the message to be displayed in the notification bar is similar to that of block 101 in above method embodiments, which is not elaborated herein.

In block 202, an application for generating the message to be displayed in the notification bar is determined.

The application for generating or pushing the message to be displayed in the notification bar is determined according to the acquired message to be displayed in the notification bar.

In block 203, it is determined whether the application is a predetermined target application.

In embodiments, when the user considers that a notification message pushed by one or some applications, such as an instant messaging application QQ or WeChat, is important and it is necessary to focus on the notification message pushed by that or those applications, enhanced display may be performed on all of the notification messages pushed by that or those applications.

In embodiments, after the user sets performing the enhanced display on the notification message pushed by that or those applications, that or those applications are determined as the predetermined target application discussed in embodiments.

After determining whether the application for generating the message to be displayed in the notification bar is the predetermined target application, a block 204 is executed if the application for generating the message to be displayed in the notification bar is the predetermined target application; otherwise, a block 206 is executed.

In block 204, it is determined that the condition for performing the enhanced display on the message is satisfied.

In block 205, the property of the message to be displayed in the notification bar is set, such that the enhanced display is performed on the message to be displayed in the notification bar according to the predetermined enhanced display manner.

In embodiments, the process of setting the property of the message to be displayed in the notification bar, such that the enhanced display is performed on the message to be displayed in the notification bar according to the predetermined enhanced display manner is similar to that of block 103 in the above method embodiments, which is not elaborated herein.

In block 206, the notification bar message is displayed according to the original or defaulted display manner.

In embodiments of the present disclosure, it is determined whether the application for generating the message to be displayed in the notification bar is the predetermined target application. If the application for generating the message to be displayed in the notification bar is the predetermined target application, the property of the message to be displayed in the notification bar is set, such that the enhanced display may be performed on the message to be displayed in the notification bar according to the predetermined enhanced display manner, which may attract particular attention from the user to the message to be displayed in the notification bar pushed by the target application, thereby improving the effectiveness of prompt by the notification bar.

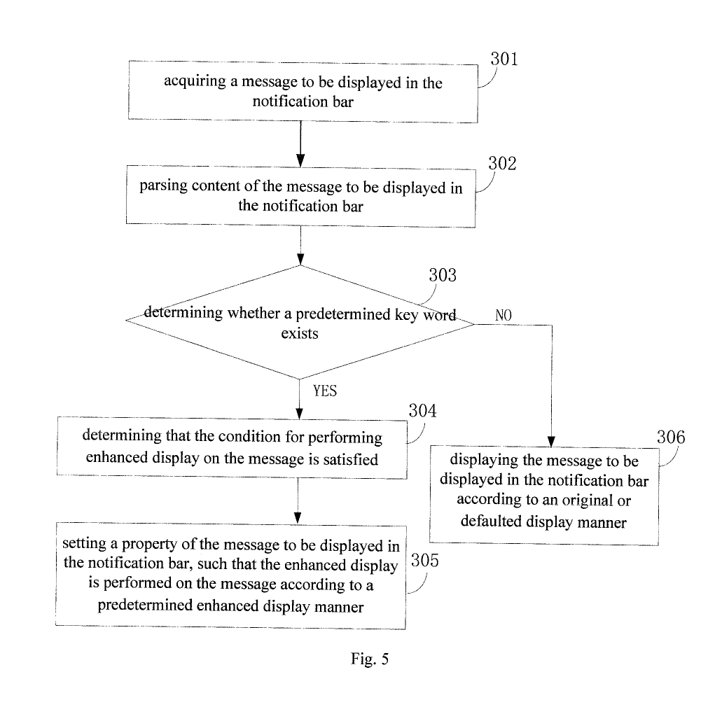

FIG. 5 is a flow chart illustrating a display method of a notification bar according to Embodiment Three of the present disclosure. As illustrated in FIG. 5, the method in Embodiment Three includes the followings.

In block 301, a message to be displayed in the notification bar is acquired.

In embodiments, a process of acquiring the message to be displayed in the notification bar is similar to that of block 101 in the above method embodiments, which is not elaborated herein.

In block 302, content of the message to be displayed in the notification bar is parsed.

In embodiments, the content of the message to be displayed in the notification bar is parsed according to the acquired message to be displayed in the notification bar.

In block 303, it is determined whether a predetermined key work exists.

In embodiments, after parsing the content of the message to be displayed in the notification bar, it is determined whether the predetermined key word exists in the content of the message to be displayed in the notification bar.

The key word may be information focused by the user, such as a specific name, a specific location, a specific event (like “meeting”) or the like.

The key word may be in a form of white list. In addition, the key word may be customized by the user, allowing adding, modifying and removing the key word by the user.

In embodiment, through the determination, when the predetermined key word exists in the content of the message to be displayed in the notification bar, a block 304 is executed; otherwise, a block 306 is executed.

In block 304, it is determined that the condition for performing the enhanced display on the message is satisfied.

In block 305, the property of the message to be displayed in the notification bar is set, such that the enhanced display may be performed on the message to be displayed in the notification bar according to the predetermined enhanced display manner.

In embodiments, the process of setting the property of the message to be displayed in the notification bar, such that the enhanced display is performed on the message to be displayed in the notification bar according to the predetermined enhanced display manner is similar to that of block 103 discussed in the above method embodiment, which is not elaborated herein.

In block 306, the message to be displayed in the notification bar is displayed according to the original or defaulted display manner.

In embodiments of the present disclosure, by parsing the content of the message to be displayed in the notification bar, it is determined whether the predetermined key word exists in the content of the message to be displayed in the notification bar. If the predetermined key word exists in the content of the message to be displayed in the notification bar, the property of the message to be displayed in the notification bar is set, such that the enhanced display may be performed on the message to be displayed in the notification bar according to the predetermined enhanced display manner. Therefore, particular attention is attacked to the message to be displayed in the notification bar including the predetermined key word from the user, thereby improving the effectiveness of prompt by the notification bar.

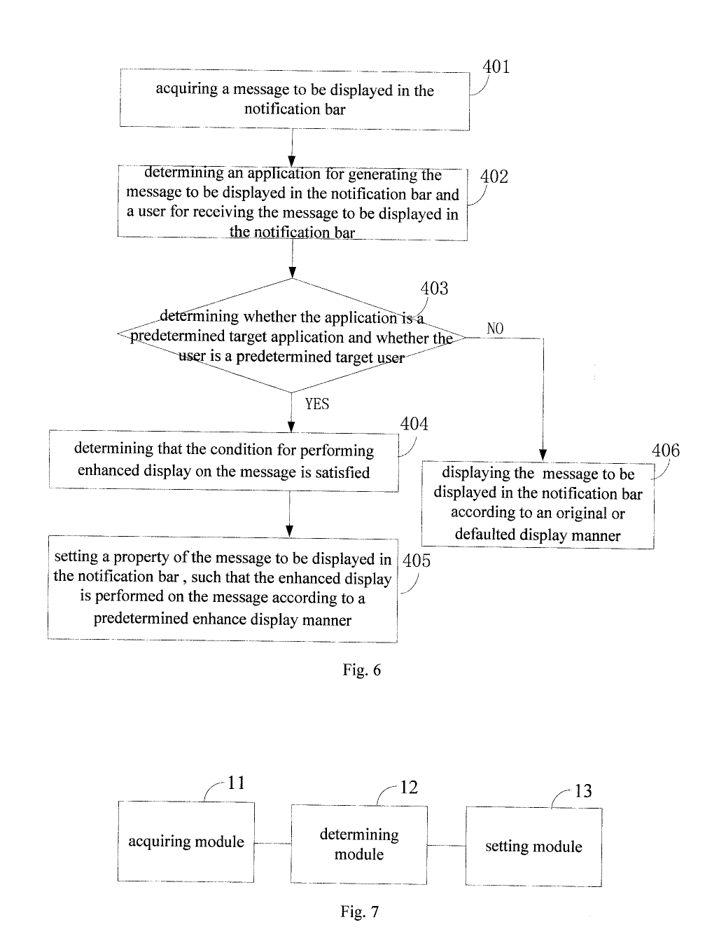

FIG. 6 is a flow chart illustrating a display method of a notification bar according to Embodiment Four of the present disclosure. As illustrated in FIG. 6, the method in embodiments may include the followings.

In block 401, a message to be displayed in the notification bar is acquired.

In embodiments, a process of acquiring the message to be displayed in the notification bar is similar to that of the block 101 discussed in the above method embodiment, which is not elaborated herein.

In block 402, an application for generating the message to be displayed in the notification bar is determined, and a user for receiving the message to be displayed in the notification bar is determined.

In embodiments, the application for generating the message to be displayed in the notification bar and the user for receiving the message to be displayed in the notification bar are determined according to the acquired message to be displayed in the notification bar.

The user for receiving the message to be displayed in the notification bar is a target user to which the message to be displayed in the notification bar generated by the application is pushed, for example a user of a terminal installing the application having capability of pushing the message to be displayed in the notification bar. The user may be determined by acquiring an identity number of a mobile terminal (such as a phone) for receiving the message to be displayed in the notification bar.

In block 403, it is determined whether the application is the predetermined target application and whether the user is a predetermined target user.

In embodiments, the usage habit of the user for applications may be analyzed in advance to determine which user is interested in which application. For example, after the analysis, it may be determined that the user A is interested in an online game A. Therefore, the online game A may be determined as the predetermined target application and the user A may be determined as the predetermined target user.

After the determination, when the application for generating the message to be displayed in the notification bar is the predetermined target application, and the user for receiving the message to be displayed in the notification bar is the predetermined target user, for example, the application for generating the message to be displayed in the notification bar is the online game A while the user for receiving the message to be displayed in the notification bar is the user A as described in the above example, a block 404 is executed; otherwise, a block 406 is executed.

In block 404, it is determined that the condition for performing enhanced display on the message is satisfied.

In block 405, the property of the message to be displayed in the notification bar is set, such that the enhanced display is performed on the message to be displayed in the notification bar according to a predetermined enhanced display manner.

In embodiments, a process of setting the property of the message to be displayed in the notification bar such that the enhanced display is performed on the message to be displayed in the notification bar according to the predetermined enhanced display manner is similar to that of block 103 discussed in the above method embodiment, which is not elaborated herein.

In block 406, the message to be displayed in the notification bar is displayed according to an original or defaulted display manner.

In embodiments of the present disclosure, the application for generating the message to be displayed in the notification bar and the user for receiving the message to be displayed in the notification bar are collectively determined. When the application for generating the message to be displayed in the notification bar is the target application and the user for receiving the message to be displayed in the notification bar is the target user, the property of the message to be displayed in the notification bar is set, such that the enhanced display is performed on the message to be displayed in the notification bar according to the predetermined enhanced display manner. Therefore, specific attention may be attacked from the target user to the message to be displayed in the notification bar generated by the target application, thereby improving effectiveness of prompt by the notification bar.

FIG. 7 is a schematic diagram illustrating a display device of a notification bar according to Embodiment One of the present disclosure. As illustrated in FIG. 7, the display device according to Embodiment One may include an acquiring module 11, a determining module 12 and a setting module 13. The acquiring module 11 is configured to acquire a message to be displayed in the notification bar. The determining module 12 is configured to determine whether a condition for performing enhanced display on the message is satisfied according to the message to be displayed in the notification bar acquired by the acquiring module. The setting module 13 is configured to set the property of the message to be displayed in the notification bar when the condition for performing enhanced display on the message is satisfied according to the determination of the determining module, such that the enhanced display is performed on message to be displayed in the notification bar according to a predetermined enhanced display manner.

Alternatively, in embodiments, the acquiring module 11 is further configured to acquire a message to be sent to the notification bar in a system application framework layer as the message to be displayed in the notification bar. Alternatively, the acquiring module 11 is configured to inject an interception program into a message progress of the notification bar to acquire the message to be displayed in the notification bar. Alternatively, the acquiring module 11 is configured to acquire a usage permission of the notification bar and monitor a message to be displayed in notification bar in the system to acquire the message to be displayed in the notification bar.

The setting module 13 is further configured to set at least one of followings on the basis of original properties of the message to be displayed in the notification bar.

A key word in content of the message to be displayed in the notification bar is set to a predetermined color and/or a predetermined font.

A prompt effect in sound or in vibration is set.

Displaying priority information is set.

A first prompt mark is set. The first prompt mark represents that the notification bar is an enhanced prompt notification bar.

A second prompt mark is set. The second prompt mark represents an application for generating the message to be displayed in the notification bar.

Alternatively, the display device of a notification bar may further include a cancelling module and an enhanced display module. The cancelling module is configured to cancel to display an original notification bar configured for displaying the message to be displayed in the notification bar in. The enhanced display module is configured to display the message to be displayed in the notification bar in a newly established notification bar according to the predetermined enhanced display manner.

The display device in embodiments is configured to execute technical solutions described in embodiments illustrated in FIG. 2, realization principles and technical effects are similar to each other, which are not elaborated herein.

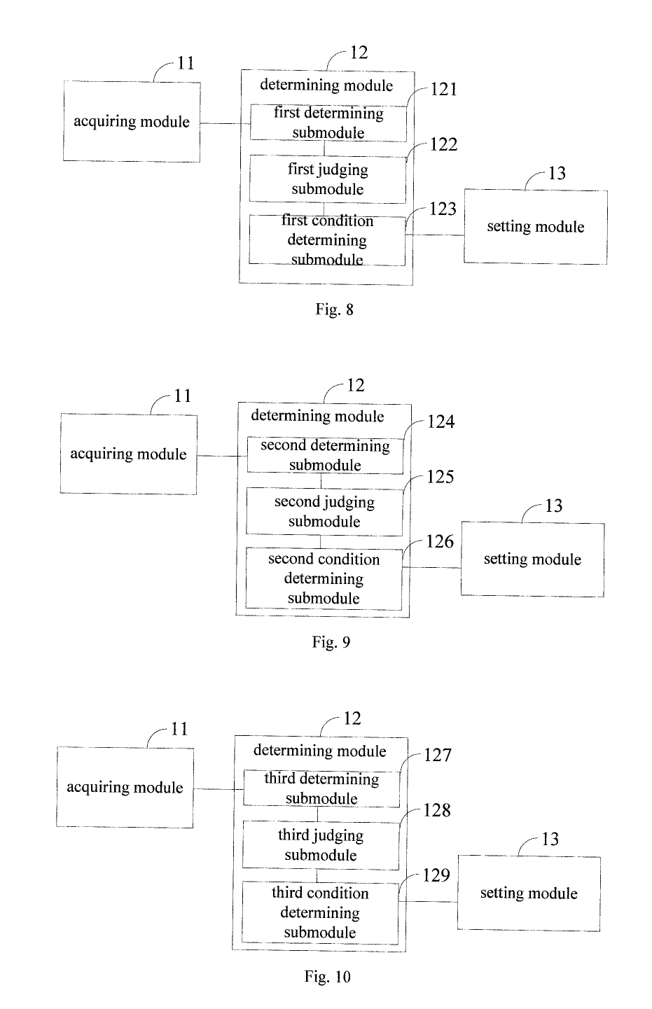

FIG. 8 is a block diagram illustrating a display method of a notification bar according to Embodiment Two of the present disclosure. As illustrated in FIG. 8, on the basis of the display device illustrated in FIG. 7, the determining module 12 of the display device in Embodiment Two further includes a first determining submodule 121, a first judging submodule 122 and a first condition determining submodule 123. The first determining submodule 121 is configured to determine an application for generating the message to be displayed in the notification bar according to the message to be displayed in the notification bar acquired by the acquiring module. The first judging submodule 122 is configured to determine whether the application for generating the message to be displayed in the notification bar is a predetermined target application. The first condition determining submodule 123 is configured to determine that the condition for performing enhanced display on the message is satisfied when the application for generating the message to be displayed in the notification bar is the predetermined target application determined by the first determining submodule.

The display device provided in embodiments may be used to execute technical solutions of the above method embodiments illustrated in FIG. 2 or 4, realization principles and technical effects are similar, which are not elaborated herein.

FIG. 9 is a block diagram illustrating a display device of a notification bar according to Embodiment Three of the present disclosure. As illustrated in FIG. 9, on the basis of a structure of the display device illustrated in FIG. 7, the determining module 12 of the display device in Embodiment Three may include a second determining submodule 124, a second judging submodule 125 and a second condition determining submodule 126. The second determining submodule 124 is configured to parse content of the message to be displayed in the notification bar according to the message to be displayed in the notification bar acquired by the acquiring module. The second judging submodule 125 is configured to determine whether a predetermined key word exists in the content of the message to be displayed in the notification bar. The second condition determining submodule 126 is configured to determine that the condition for performing the enhanced display on the message to be displayed in the notification bar is satisfied when the predetermined key word exists in the content of the message to be displayed in the notification bar according to the determination of the second judging submodule.

The display device in embodiments may be configured to execute technical solutions of the above method embodiments illustrated as FIG. 2 or FIG. 5, realization principles and technical effects are similar, which are not elaborated herein.

FIG. 10 is a block diagram illustrating a display device of a notification bar according to Embodiment Four of the present disclosure. As illustrated in FIG. 10, on the basis of a structure of the display device illustrated as FIG. 7, the determining module 12 of the display device in Embodiment Four further includes a third determining submodule 127, a third judging module 128 and a third condition determining submodule 129. The third determining submodule 127 is configured to determine an application for generating the message to be displayed in the notification bar and a user for receiving the message to be displayed in the notification bar, according to the message to be displayed in the notification bar acquired by the acquiring module. The third judging submodule 128 is configured to determine whether the application for generating the message to be displayed in the notification bar is a predetermined target application and whether the user for receiving the message to be displayed in the notification bar is a predetermined target user. The third condition determining submodule 129 is configured to determine that the condition for performing the enhanced display on the message is satisfied when the application for generating the message to be displayed in the notification bar is the predetermined target application and the user for receiving the message to be displayed in the notification bar is the predetermined target user according to the determination of the third judging submodule.

The display device in embodiments may be configured to execute technical solutions of the above method embodiments illustrated as FIG. 2 or FIG. 6, realization principles and technical effects are similar, which are not elaborated herein.

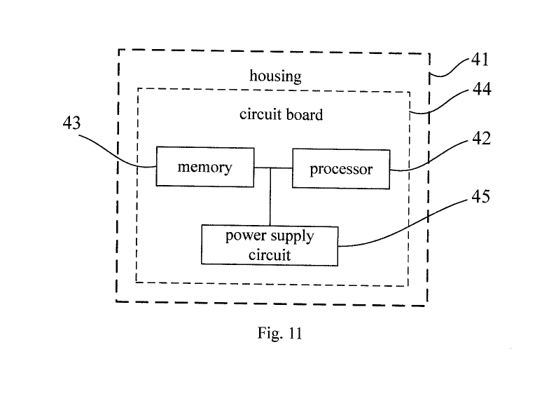

FIG. 11 is a schematic diagram illustrating an electronic device according to an embodiment of the present disclosure, which may implement the flow chart illustrated as FIG. 2, FIG. 4 or FIG. 6. As illustrated in FIG. 11, the electronic device may include a housing 41, a processor 42, a memory 43, a circuit board 44 and a power supply circuit 45. The circuit board 44 is enclosed by the housing 41. The processor 42 and the memory 43 are positioned on the circuit board 44. The power supply circuit 45 is configured to provide power for respective circuits or components of the above electronic device. The memory 43 is configured to store executable program codes. The processor 42 is configured to run programs corresponding to the executable program codes by reading the executable program codes stored in the memory 42, such that the display method of a notification bar according to any one of the above embodiments is executed.

The detailed process of executing the above display method by the processor 42 and details of executing the above display method by the processor 42 by running the executable program codes may be referred to the descriptions made to embodiments of FIG. 2, FIG. 4 and FIG. 6, which are not elaborated herein.

The electronic device may have various forms, including but not limited to the followings.

(1) A mobile communication device. This type of device has a capacity of mobile communication, and has a main function to provide voice, data communication. This type of device includes a smart phone (such as an iPhone), a multimedia phone, a functional phone and a low-level phone.

(2) A super-mobile personal computer device. This type of device pertains to a personal computer, having a capacity of computing and processing and generally having a capacity of accessing mobile Internet. This type of device includes: PDA (Personal Digital Assistant), MID (Mobile Internet Device) and UMPC (Ultra-mobile Personal Computer) devices, such as an iPad.

(3) Portable entertainment equipment. This type of device may display or play multimedia content. This type of device includes: an audio and video player (such as iPod), a handheld game player, an E-book, intelligent playthings, and portable on-vehicle navigation equipment.

(4) A server. The server is a device for providing computing services. Components of the server include a processor, a hard disk, a memory, a systematical bus or the like. The server is similar to a general computer framework. Since it needs to provide highly reliable services, demands in aspects, such as processing capacity, stability, reliability, security, extensibility, manageability are relatively high.

(5) Other electronic devices having a capacity of data interaction.

Embodiments of the present disclosure provide a storage medium, configured to store an application. The application is configured to execute the display method of a notification bar according to embodiments of a first aspect of the present disclosure.

It is to be illustrated that, in the specification, terms such as “first” and “second” are configured herein for distinguishing one entity or operation from another entity or operation, but may not indicate or imply that these entities and operations have an actual relation and an actual sequence regarding to each other. Furthermore, the terms such as “include”, “comprise” and any other variations are intended to be non-exclusive and covering-meaning, such that a process, a method, a subject or a device including or comprising a sequence of components not only includes or comprises those components, but includes or comprises other components that are not listed in the sequence, or further includes or comprises inherent components of the process, the method, the subject or the device. Without any more limitations, components defined by a sentence such as “include a . . . or comprise a . . . ” are not exclusive to be included or comprised in the process, the method, the subject or the device, further they include or comprise other additional components.

Embodiments of the specification are described in relation with other embodiments. Similar parts of the embodiments may be referred to other embodiments. The description made to each embodiment emphasizes differences from other embodiments.

Particularly, as being similar to the method embodiments, device embodiments are described simply. Details may be referred to corresponding parts of the device embodiments.

For the convenience of descriptions, the above devices are described as being separately divided into various units/modules. Certainly, the functions of each unit/module can be implemented in the same software or software and/or hardware when implementing the present application.

It may be understood by those skilled in the art that, all of or a part of steps for achieving above method embodiments may be realized by instructing related software via computer programs. The computer programs may be stored in a computer readable storage medium. When the computer programs are executed, the method in above embodiments may be included. The storage medium may be a magnetic disk, an optical disk, a read-only storage memory (Read-Only notification bar display device, Memory notification bar display device, ROM) or a random storage memory (Random Access Memory notification bar display device, RAM), etc. . . . .

The above embodiments are merely specific embodiments of the present disclosure, but are not construed to limit a protection scope of the present disclosure. Changes and alternatives that may be easily conceived within the technical scope of the present disclosure by those skilled in the art should be covered by the scope of the present disclosure. Therefore, the scope of protection of this present disclosure should be determined by the scope of protection of the claims.

What is claimed is:

1. A display method of a notification bar, comprising:
acquiring a message to be displayed in the notification bar;
determining whether a condition for performing enhanced display on the message is satisfied according to the message to be displayed in the notification bar; and
when the condition for performing enhanced display on the message is satisfied, setting a property of the message to be displayed in the notification bar, such that the enhanced display is performed on message to be displayed in the notification bar according to a predetermined enhanced display manner;
wherein determining whether the condition for performing the enhanced display on the message is satisfied according to the message to be displayed in the notification bar comprises:
determining an application for generating the message to be displayed in the notification bar according to the message to be displayed in the notification bar;
determining whether the application for generating the message to be displayed in the notification bar is a predetermined target application; and
determining that the condition for performing the enhanced display on the message is satisfied when the application for generating the message to be displayed in the notification bar is the predetermined target application;
or,
determining whether the condition for performing the enhanced display on the message is satisfied according to the message to be displayed in the notification bar comprises:
parsing content of the message to be displayed in the notification bar according to the message to be displayed in the notification bar;
determining whether a predetermined key word exists in the content of the message to be displayed in the notification bar; and
when the predetermined key word exists in the content of the message to be displayed in the notification bar, determining that the condition for performing the enhanced display on the message is satisfied;
or,
determining whether the condition for performing the enhanced display on the message is satisfied according to the message to be displayed in the notification bar comprises:
determining an application for generating the message to be displayed in the notification bar and a user for receiving the message to be displayed in the notification bar according to the message to be displayed in the notification bar;
determining whether the application for generating the message to be displayed in the notification bar is a predetermined target application and whether the user for receiving the message to be displayed in the notification bar is a predetermined target user; and
when the application for generating the message to be displayed in the notification bar is the predetermined target application and the user for receiving the message to be displayed in the notification bar is the predetermined target user, determining that the condition for performing the enhanced display on the message is satisfied.

2. The display method according to claim 1, wherein acquiring the message to be displayed in the notification bar comprises:
acquiring a message to be sent to the notification bar in a system application framework layer as the message to be displayed in the notification bar; or
injecting an interception program into a message progress of the notification bar to acquire the message to be displayed in the notification bar; or
acquiring a usage permission of the notification bar and monitoring a message to be displayed in the notification bar in a system to acquire the message to be displayed in the notification bar.

3. The display method according to claim 2, wherein when the message to be displayed in the notification bar is acquired by monitoring the message to be displayed in the notification bar in the system after acquiring the usage permission of the notification bar, performing the enhanced display on the message to be displayed in the notification bar according to the predetermined enhanced display manner comprises:
cancelling to display an original notification bar configured for displaying the message to be displayed in the notification bar; and
displaying the message to be displayed in the notification bar in a newly established notification bar according to the predetermined enhanced display manner.

4. The display method according to claim 1, wherein setting the property of the message to be displayed in the notification bar comprises: based on an original property of the message to be displayed in the notification bar, performing at least one of:
setting a key word in content of the message to be displayed in the notification bar to a predetermined color and/or a predetermined font;
setting a prompt effect in sound or in vibration;
setting displaying priority information;
setting a first prompt mark, the first prompt mark representing that a notification bar is an enhanced prompt notification bar; and
setting a second prompt mark, the second prompt mark representing an application for generating the message to be displayed in the notification bar.

5. The display method according to claim 1, wherein performing the enhanced display on the message to be displayed in the notification bar according to the predetermined enhanced display manner comprises:
displaying the message to be displayed in the notification bar in an original established notification bar according to the predetermined enhanced display manner.

6. The display method according to claim 1, further comprising:
when the condition for preforming the enhanced display on the message is not satisfied, displaying the message to be displayed in the notification bar according to an original or defaulted display manner.

7. The display method according to claim 1, wherein the predetermined key word is customized by a user and comprises a customized name, a customized location or a customized event.

8. The display method according to claim 1, wherein the user for receiving the message to be displayed in the notification bar is determined according an identify number of a mobile terminal for receiving the message to be displayed in the notification bar.

9. An electronic device, comprising a housing, a processor, a memory, a circuit board and a power supply circuit; wherein the circuit board is enclosed by the housing; the processor and the memory are positioned on the circuit board; the power supply circuit is configured to provide power for respective circuits or components of the terminal device; the memory is configured to store executable program codes; and the processor is configured to run a program corresponding to the executable program codes by reading the executable program codes stored in the memory, to perform the display method of a notification bar, the display method comprises:
acquiring a message to be displayed in the notification bar;
determining whether a condition for performing enhanced display on the message is satisfied according to the message to be displayed in the notification bar; and
when the condition for performing enhanced display on the message is satisfied, setting a property of the message to be displayed in the notification bar, such that the enhanced display is performed on message to be displayed in the notification bar according to a predetermined enhanced display manner;
wherein determining whether the condition for performing the enhanced display on the message is satisfied according to the message to be displayed in the notification bar comprises:
determining an application for generating the message to be displayed in the notification bar according to the message to be displayed in the notification bar;
determining whether the application for generating the message to be displayed in the notification bar is a predetermined target application; and
determining that the condition for performing the enhanced display on the message is satisfied when the application for generating the message to be displayed in the notification bar is the predetermined target application;
or,
determining whether the condition for performing the enhanced display on the message is satisfied according to the message to be displayed in the notification bar comprises:
parsing content of the message to be displayed in the notification bar according to the message to be displayed in the notification bar;
determining whether a predetermined key word exists in the content of the message to be displayed in the notification bar; and
when the predetermined key word exists in the content of the message to be displayed in the notification bar, determining that the condition for performing the enhanced display on the message is satisfied;
or,
determining whether the condition for performing the enhanced display on the message is satisfied according to the message to be displayed in the notification bar comprises:
determining an application for generating the message to be displayed in the notification bar and a user for receiving the message to be displayed in the notification bar according to the message to be displayed in the notification bar;
determining whether the application for generating the message to be displayed in the notification bar is a predetermined target application and whether the user for receiving the message to be displayed in the notification bar is a predetermined target user; and
when the application for generating the message to be displayed in the notification bar is the predetermined target application and the user for receiving the message to be displayed in the notification bar is the predetermined target user, determining that the condition for performing the enhanced display on the message is satisfied.

10. The electronic device according to claim 9, wherein acquiring the message to be displayed in the notification bar comprises:
acquiring a message to be sent to the notification bar in a system application framework layer as the message to be displayed in the notification bar; or
injecting an interception program into a message progress of the notification bar to acquire the message to be displayed in the notification bar; or
acquiring a usage permission of the notification bar and monitoring a message to be displayed in the notification bar in a system to acquire the message to be displayed in the notification bar.

11. The electronic device according to claim 10, wherein when the message to be displayed in the notification bar is acquired by monitoring the message to be displayed in the notification bar in the system after acquiring the usage permission of the notification bar, performing the enhanced display on the message to be displayed in the notification bar according to the predetermined enhanced display manner comprises:
cancelling to display an original notification bar configured for displaying the message to be displayed in the notification bar; and
displaying the message to be displayed in the notification bar in a newly established notification bar according to the predetermined enhanced display manner.

12. The electronic device according to claim 9, wherein setting the property of the message to be displayed in the notification bar comprises: based on an original property of the message to be displayed in the notification bar, performing at least one of:
setting a key word in content of the message to be displayed in the notification bar to a predetermined color and/or a predetermined font;
setting a prompt effect in sound or in vibration;
setting displaying priority information;
setting a first prompt mark, the first prompt mark representing that a notification bar is an enhanced prompt notification bar; and
setting a second prompt mark, the second prompt mark representing an application for generating the message to be displayed in the notification bar.

13. The electronic device according to claim 9, wherein performing the enhanced display on the message to be displayed in the notification bar according to the predetermined enhanced display manner comprises:
displaying the message to be displayed in the notification bar in an original established notification bar according to the predetermined enhanced display manner.

14. The electronic device according to claim 9, wherein the display method further comprises:
when the condition for preforming the enhanced display on the message is not satisfied, displaying the message to be displayed in the notification bar according to an original or defaulted display manner.

15. A non-transitory computer readable storage medium, configured to store an application, wherein the application is configured to execute the display method of a notification bar, the display method comprises:
acquiring a message to be displayed in the notification bar;
determining whether a condition for performing enhanced display on the message is satisfied according to the message to be displayed in the notification bar; and
when the condition for performing enhanced display on the message is satisfied, setting a property of the message to be displayed in the notification bar, such that the enhanced display is performed on message to be displayed in the notification bar according to a predetermined enhanced display manner;
wherein determining whether the condition for performing the enhanced display on the message is satisfied according to the message to be displayed in the notification bar comprises:
determining an application for generating the message to be displayed in the notification bar according to the message to be displayed in the notification bar;
determining whether the application for generating the message to be displayed in the notification bar is a predetermined target application; and
determining that the condition for performing the enhanced display on the message is satisfied when the application for generating the message to be displayed in the notification bar is the predetermined target application;
or,
determining whether the condition for performing the enhanced display on the message is satisfied according to the message to be displayed in the notification bar comprises:
parsing content of the message to be displayed in the notification bar according to the message to be displayed in the notification bar;
determining whether a predetermined key word exists in the content of the message to be displayed in the notification bar; and
when the predetermined key word exists in the content of the message to be displayed in the notification bar, determining that the condition for performing the enhanced display on the message is satisfied;
or,
determining whether the condition for performing the enhanced display on the message is satisfied according to the message to be displayed in the notification bar comprises:
determining an application for generating the message to be displayed in the notification bar and a user for receiving the message to be displayed in the notification bar according to the message to be displayed in the notification bar;
determining whether the application for generating the message to be displayed in the notification bar is a predetermined target application and whether the user for receiving the message to be displayed in the notification bar is a predetermined target user; and
when the application for generating the message to be displayed in the notification bar is the predetermined target application and the user for receiving the message to be displayed in the notification bar is the predetermined target user, determining that the condition for performing the enhanced display on the message is satisfied.

16. The non-transitory computer readable storage medium according to claim 15, wherein acquiring the message to be displayed in the notification bar comprises:
acquiring a message to be sent to the notification bar in a system application framework layer as the message to be displayed in the notification bar; or
injecting an interception program into a message progress of the notification bar to acquire the message to be displayed in the notification bar; or
acquiring a usage permission of the notification bar and monitoring a message to be displayed in the notification bar in a system to acquire the message to be displayed in the notification bar.

17. The non-transitory computer readable storage medium according to claim 16, wherein when the message to be displayed in the notification bar is acquired by monitoring the message to be displayed in the notification bar in the system after acquiring the usage permission of the notification bar, performing the enhanced display on the message to be displayed in the notification bar according to the predetermined enhanced display manner comprises:
cancelling to display an original notification bar configured for displaying the message to be displayed in the notification bar; and
displaying the message to be displayed in the notification bar in a newly established notification bar according to the predetermined enhanced display manner.

18. The non-transitory computer readable storage medium according to claim 15, wherein setting the property of the message to be displayed in the notification bar comprises: based on an original property of the message to be displayed in the notification bar, performing at least one of:
setting a key word in content of the message to be displayed in the notification bar to a predetermined color and/or a predetermined font;
setting a prompt effect in sound or in vibration;
setting displaying priority information;
setting a first prompt mark, the first prompt mark representing that a notification bar is an enhanced prompt notification bar; and
setting a second prompt mark, the second prompt mark representing an application for generating the message to be displayed in the notification bar.

19. The non-transitory computer readable storage medium according to claim 15, wherein performing the enhanced display on the message to be displayed in the notification bar according to the predetermined enhanced display manner comprises:
displaying the message to be displayed in the notification bar in an original established notification bar according to the predetermined enhanced display manner.

20. The non-transitory computer readable storage medium according to claim 15, wherein the display method further comprises: when the condition for preforming the enhanced display on the message is not satisfied, displaying the message to be displayed in the notification bar according to an original or defaulted display manner.
